(19) United States
(12) Patent Application Publication
(10) Pub. No.: US 2013/0137461 A1
(43) Pub. Date: May 30, 2013

(54) METHOD AND APPARATUS FOR INSERTING LOCATION DATA INTO MESSAGES AT A COMMUNICATION GATEWAY

(71) Applicants: Carlos Manzanares Sancho, Tampere (FI); Caio Bottiglieri, Sao Paulo (BR); Irving Benjamin Cordova, San Jose, CA (US); Konrad Garlikowski, Wroclaw (PL); Duncan Sample, Huntingdon (GB); Mikhael Harswanto Tanutama, San Jose, CA (US)

(72) Inventors: Carlos Manzanares Sancho, Tampere (FI); Caio Bottiglieri, Sao Paulo (BR); Irving Benjamin Cordova, San Jose, CA (US); Konrad Garlikowski, Wroclaw (PL); Duncan Sample, Huntingdon (GB); Mikhael Harswanto Tanutama, San Jose, CA (US)

(73) Assignee: NOKIA SIEMENS NETWORKS OY, Espoo (FI)

(21) Appl. No.: 13/696,813

(22) PCT Filed: May 5, 2011
(86) PCT No.: PCT/EP11/57181

§ 371 Date: Feb. 4, 2013

Related U.S. Application Data
(63) Continuation of application No. 12/776,891, filed on May 10, 2010, now abandoned.

(51) Int. Cl. H04W 4/02

(52) U.S. Cl. CPC H04W 4/02
USPC 455/456.3

(57) ABSTRACT

The present invention relates to methods and apparatus for enabling location data for a user to be included in communication messages from the user. A communication message is received from a mobile device of the user wherein the communication message is addressed to or intended for a location based service. A request message is transmitted for a location data of the mobile device to a mobile operator of the user. A response message is received from the mobile operator wherein the response message includes the location data for the mobile device. The communication message is processed to include the received location data for the mobile device and the processed communication message is transmitted to the location based service.

The present invention relates to communication gateway.

Presently, there are an increasing number of location based services and applications that may be utilised by users via a mobile device. The location based services that are currently offered may be directed to many different and varying aspects. For example, the location based services may be directed to providing information such as points of interest to the user in the area of the location of the user's mobile device. The location based services may be directed to indicating to the user that a social network friend is entering or within an area of the location of the user's mobile device. Other location based services may be directed to games which may be based on the location of the user's mobile device. As will be appreciated by a person skilled in the art there are many more location based services presently available and that will be developed in the future.

Location based services also includes applications that may utilise location data of the user's mobile device in order to enhance or enrich the application that the user is using.

The location based services (LBS) therefore need to obtain location data relating to the user's mobile device in order to be able to provide the location based service that the user wishes to access or utilise.

The LBS may obtain location data relating to the location of the user's mobile device from the mobile device. However, this requires the mobile device to be a so-called “high-end” mobile device which may utilise, for example, Global Positioning System (GPS) applications on the mobile device which can determine the location of the mobile device.

Alternatively, the LBS may obtain location data relating to the location of the user's mobile device from the mobile operator of the user. In order for a user to use their mobile device to make and receive communication the user will typically have a subscription with a particular mobile operator. The mobile operator may determine the location data of the user's mobile device based on several factors, for example, the cell area of a Base Transceiver Station (BTS) that the mobile device is operatively connected to or in communication with. However, in order for the mobile operator to provide location data relating to a user to a LBS the mobile operator must be able to trust the LBS and/or the LBS has to be part of the telecommunication domain, e.g. developed by or for a mobile operator. Furthermore, the LBS in order to obtain location data of a user from the mobile operator may require telecommunication knowledge which increases the complexity and difficulty of developing and providing LBSs.

Cloud Computing is a paradigm that moves resources, services and applications into a cloud enabling users to access and utilise the resources, services and applications. The cloud may refer to delivering resources, services and applications over the Internet which are sold/used on demand and provides substantial flexibility.

Therefore, more services and applications are being pushed into the “cloud” out of the traditional telecommunication domain dominated by the mobile operators and infrastructure operators.

Accordingly, there is a need to enable “low-end” mobile devices to access and use LBS, particularly those LBSs that are being implemented in the cloud. There is also a need to enable LBSs to be developed for the cloud which do not have to be trusted by mobile operators in order to obtain location data of a user's mobile device. The present invention may seek to address one or more of these needs.

According to a first aspect of the present invention there is provided a method comprising: receiving a communication message from a mobile device of a user wherein the communication message is addressed to a location based service; transmitting a request message for a location data of the mobile device to a mobile operator of the user; receiving a response message from the mobile operator wherein the response message includes the location data for the mobile device; processing the communication message to include the received location data for the mobile device; and transmitting the processed communication message to the location based service.

Accordingly, the method receives a communication message from a mobile device destined for a location based service and obtains location data for the mobile device. The location data obtained may then be included in the communication message which may be transmitted to the location based service. The method may be implemented to operate a gateway or provide gateway functionality.

Thus, many of the embodiments of the present invention advantageously enable location based services to be located outside of the trusted domain of the mobile operators. This is because the method, e.g. gateway, interacts with the mobile operator in order to obtain location data for a mobile device meaning that the location based service does not have to interact with or be trusted by the mobile operators. As the method obtains the location data for the mobile device then the mobile device may be a low-end mobile device, in other words, a mobile device that does not require any applications to be installed and activated on the mobile device other than to transmit and receive communication messages.

The communication message may be a Short Message Service (SMS) message, Multimedia Message Service (MMS) message or any other communication message that may be transmitted from a mobile device. The mobile device may be any mobile device that is mobile and may transmit communication messages such as a mobile telephone.

The location based service may be any service or application that provides information, services, and so on, based on the location data of the mobile device.

The method may further comprise determining the received communication message is addressed to a location based service.

The method may further comprise identifying the mobile operator based on the received communication message; and wherein the request message transmitted to the identified mobile operator may include an identification of the mobile device. The mobile operator of the user of the mobile device may be identified so that the request message for the location data of the mobile device may be transmitted to the relevant mobile operator, in other words the mobile operator to which the user is subscribed. In order to enable the mobile operator to respond with the location data of the mobile device the request message may also include an identification of the mobile device. The request message may include an identification of the user of the mobile device either instead of, or with, the identification of the mobile device.

The mobile operator may identify the location area of the mobile device of the user by many different mechanisms. For example, the location data received from the mobile operator may identify an area based on the cell that the mobile device communicated with to transmit the communication message.

The step of processing the communication message to include the received location data may comprise the step of appending the received location data to the communication message. Alternatively, the location data may be inserted into the body of the communication message or may be inserted into the header information of the communication message.

The received communication message may be stored on a storage medium. The received location data may be stored on a storage medium.

According to a second aspect of the present invention there is provided an apparatus comprising: a first input adapted to receive a communication message from a mobile device of a user wherein the communication message is addressed to a location based service; a first output adapted to transmit a request message for a location data of the mobile device to a mobile operator of the user; a second input adapted to receive a response message from the mobile operator wherein the response message includes the location data for the mobile device; a first processor adapted to process the communication message to include the received location data for the mobile device; and a second output adapted to transmit the processed communication message to the location based service.

According to a third aspect of the present invention there is provided an apparatus adapted to: receive a communication message from a mobile device of a user wherein the communication message is addressed to a location based service; transmit a request message for a location data of the mobile device to a mobile operator of the user; receive a response message from the mobile operator wherein the response message includes the location data for the mobile device; process the communication message to include the received location data for the mobile device; and transmit the processed communication message to the location based service.

The apparatus may further comprise a second processor adapted to determine the received communication message is addressed to a location based service.

The apparatus may further comprise a third processor adapted to identify the mobile operator based on the received communication message; and wherein the third processor is further adapted include an identification of the mobile device in the request message.

The first processor may be adapted to process the communication message to append the received location data to the communication message.

The apparatus may be a computing device, a server or a gateway device. The first input and second input may be the same input or different inputs. The first output and second output may be the same output or different outputs. The first processor, second processor and third processor may be the same processor, different processors or any combination thereof.

As a skilled person in the art will appreciate, the apparatus may be adapted to perform the functions in many different ways. For example, the apparatus may be adapted by hardware, software or any combination thereof.

According to a fourth aspect of the present invention there is provided a computer program product comprising computer readable executable code for: receiving a communication message from a mobile device of a user wherein the communication message is addressed to a location based service; transmitting a request message for a location data of the mobile device to a mobile operator of the user; receiving a response message from the mobile operator wherein the response message includes the location data for the mobile device; processing the communication message to include the received location data for the mobile device; and transmitting the processed communication message to the location based service.

The computer program product may further comprise computer readable executable code for performing any or all of the functions in accordance with the aspects of the invention.

Embodiments of the present invention will now be described, by way of example only, and with reference to the accompanying drawings, in which:

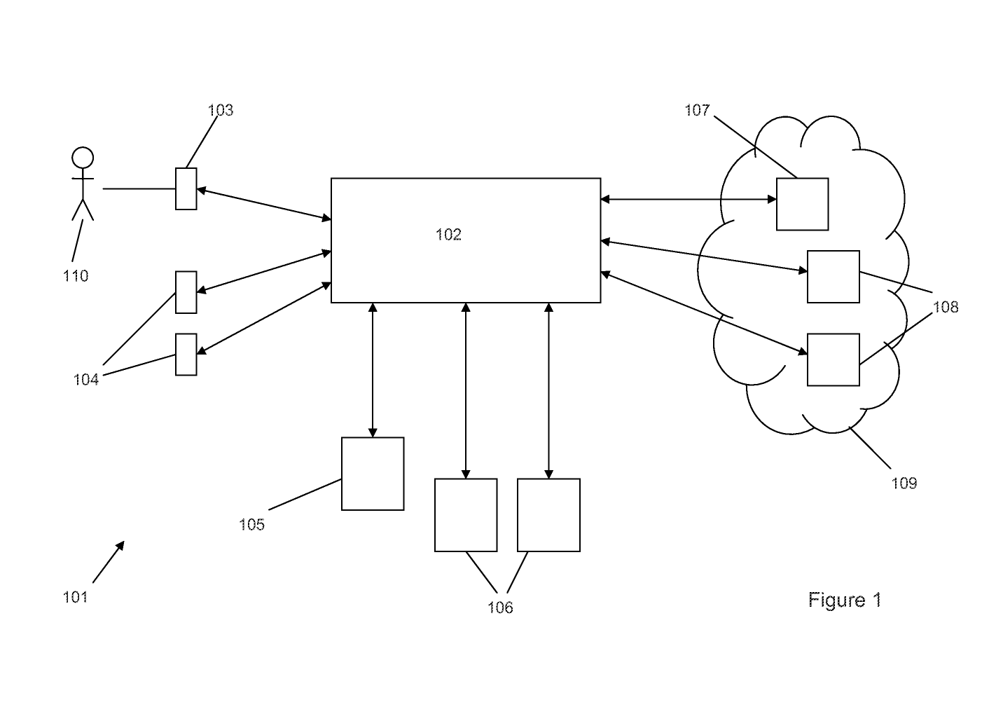

FIG. 1 shows a simplified block structure of a system in accordance with many of the embodiments of the present invention.

Many of the embodiments of the present invention will now be described with reference to FIG. 1. The system 101 includes a gateway 102 which may be operatively connected to mobile devices 103, 104, operatively connected to mobile operators 105, 106, and operatively connected to LBSs 107, 108 which may be located in the cloud 109.

The gateway 102 may be implemented as a separate platform or computing device such as a server or may be implemented as functionality that is located in, or part of, the telecommunication domain. The gateway 102 may be located in the cloud 109 and therefore may be offered as a service, resource or platform on the cloud 109.

A user 110 of the mobile device 103 is subscribed to mobile operator 105 so that the mobile device 103 may connect and communicate with mobile operator's 105 mobile access network and infrastructure in order to transmit and receive data including, for example, communication messages such as Short Message Service (SMS) messages, Multimedia Message Service (MMS) messages, and make voice calls. The mobile access network and infrastructure is not shown in FIG. 1 as a person skilled in the art would understand how a mobile device connects and communicates with a mobile access network.

The mobile device 103, 104 may be a mobile telephone or any other mobile device that may communicate with a mobile access network in order to transmit and receive data.

The LBS 107, 108 may be located or implemented in the cloud and is therefore separate to or independent from the traditional telecommunication domain in which the mobile operator 105, 106 is located. The traditional telecommunication domain typically includes the telecommunication infrastructure and management systems that enable communication to be trans-mitted across telecommunication networks, both fixed and mobile.

The user 110 may wish to access or use the LBS 107 and therefore may initiate a communication message from their mobile device 103 to the LBS 107. The communication message may include a request for the LBS 107 or may include an identifier of the LBS 107 along with any relevant information, data, instructions or requests for the LBS 107 in relation to the LBS that the user wishes to use. However, the communication message transmitted from the mobile device 103 does not include any indication of the location of the mobile device 103 which the LBS 107 will require in order to provide the relevant service.

The mobile device 103 will transmit the communication message via the mobile operator's 105 network to which the user 110 is subscribed. The gateway 102 receives the communication message and may determine that the communication message is addressed to, or intended for, the LBS 107. The gateway 102 may monitor the communication on the telecommunication network in order to effectively intercept communication messages relevant to LBSs 107, 108. The user 110 may subscribe to the gateway 102 such that communication messages transmitted from the user's 110 mobile device 103 is provided to the gateway 102. The LBSs 107, 108 may subscribe to the gateway 102 such that all communication messages transmitted to the LBSs 107, 108 are provided to the gateway 102. The mobile operators 105, 106 may subscribe to the gateway 102 such that communication messages transmitted across the mobile operator's network may be provided to the gateway 102.

Once the gateway 102 receives the communication message from the user's 110 mobile device 103 destined for the LBS 107 then the gateway 102 determines that the location of the mobile device 103 needs to be identified. The gateway 102 transmits a request message for location data of the mobile device 103 to the mobile operator 105 where the user 110 of the mobile device 103 is subscribed to or has a subscription with the mobile operator 105. The gateway 102 may determine or identify the mobile operator 105 of the mobile device 103. For example, the communication message may identify the mobile operator 105, or if the user 110 has subscribed or registered with the gateway 102 then the user 110 may provide such information, and so on.

The mobile operator 105 on receipt of the request message may proceed to determine or identify location data relating to the mobile device 103. As will be appreciated, there are several mechanisms via which location data of, or relating to, a user's 110 mobile device 103 may be determined or identified by the mobile operator 105. For example, at the point in time that the user 110 transmitted a communication message from their mobile device 103 the cell within which the mobile device 103 is located may be known by the mobile operator 105. The mobile operator 105 may apply any method or mechanism to determine or identify location data of the user's 110 mobile device 103.

The gateway 102 receives a response message from the mobile operator 105 where the response message includes location data for the mobile device 103 of the user 110. The gateway 102 identifies the location data from the received response message and may store the location data in the gateway 102.

The gateway 102 processes the communication message that was originally transmitted from the mobile device 103 of the user 110 in order to include the received location data for the mobile device 103. The communication message may be processed to include the location data by, for example, appending the location data to the communication message, adding the location data to the message body of the communication message, inserting the location data to the header or control parts of the communication message, and so on.

The gateway 102 then transmits the processed communication message (e.g. the communication message with the relevant location data included in the communication message) to the LBS 107 to which the original communication message from the mobile device 103 was addressed.

The LBS 107 may then process the received processed communication message in order to provide the LBS that the user 110 requested based on the identified location data of the user's 110 mobile device 103.

Thus, many of the embodiments enable a user with a low end mobile device (e.g. a mobile device that does not have applications installed thereon to provide location data) to utilise LBSs. The many embodiments also enable the LBS to be moved into the cloud and out of the trusted domain of the mobile operators as the location data will be obtained by the gateway which is trusted by the mobile operators. Therefore, new LBSs can be developed without detailed knowledge of the telecommunication domain and without needing to be trusted by the mobile operators.

An example of the use of the present invention will now be described, again with reference to FIG. 1.

An LBS 107 is located in the cloud 109 outside of the trusted telecommunication domain. The LBS 107 in this example is to enable user's 110 to provide reviews of restaurants that the user 110 has visited.

The user 110 once they have eaten at the restaurant may write a review of the restaurant with their thoughts and opinions on their experience at the restaurant whilst in the location of the restaurant. The user creates an SMS (e.g. communication message) on their mobile device 103. The SMS will identify at least a key word of the name of the name of the restaurant and will include their review. The user 110 will then enter the SMS address (e.g. SMS number) of the LBS 107 and transmit the SMS via their mobile device 103 to the LBS 107.

The gateway 102 receives the SMS that is addressed to the LBS 107 and identifies that location data for the user's mobile device 103 is necessary for the LBS 107 to provide the service requested by the user 110. The gateway 102 may then transmit a request message to the mobile operator 105 to which the user 110 is subscribed requesting location data for the user's mobile device 103.

The gateway 102 may then receive a response message from the mobile operator 105 where the response message includes location data for the mobile device 103 of the user 110. The gateway 102 may then process the response message in order to identify the location data and may store the location data in the gateway 102.

The gateway 102 may then process the originally received SMS from the mobile device 103 of the user 110 in order to include the location data, for example, the location data may be appended to the SMS. The gateway 102 may then transmit the SMS with the name (or keyword of the name) of the restaurant, the user's 110 review of the restaurant and the included location data to the LBS 107.

The LBS 107 based in the name of the restaurant and the location data of the mobile device 103 can identify the restaurant that the user 110 had visited. The LBS 107 may then add the review to the entry in the LBS 107 for the identified restaurant. The LBS 107 may then acknowledge receipt of the review by transmitting a communication message directly to the mobile device 103 of the user 110.

While embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method comprising:
receiving a communication message from a mobile device of a user wherein said communication message is addressed to a location based service;
transmitting a request message for a location data of said mobile device to a mobile operator of said user;
receiving a response message from said mobile operator wherein said response message includes said location data for said mobile device;
processing said communication message to include said received location data for said mobile device; and
transmitting said processed communication message to said location based service.

2. The method as claimed in claim 1 further comprising:
determining said received communication message is addressed to a location based service.

3. The method as claimed in claim 1 further comprising:
identifying said mobile operator based on said received communication message; and wherein said request message includes an identification of said mobile device.

4. The method as claimed in claim 1 in which said location data received from said mobile operator identifies an area based on the cell that the mobile device communicated with to transmit said communication message.

5. The method as claimed in claim 1 in which said step of processing said communication message to include said received location data comprises the step of:
appending said received location data to said communication message.

6. An apparatus comprising:
a first input adapted to receive a communication message from a mobile device of a user wherein said communication message is addressed to a location based service;
a first output adapted to transmit a request message for a location data of said mobile device to a mobile operator of said user;
a second input adapted to receive a response message from said mobile operator wherein said response message includes said location data for said mobile device;
a first processor adapted to process said communication message to include said received location data for said mobile device; and
a second output adapted to transmit said processed communication message to said location based service.

7. The apparatus as claimed in claim 6 further comprising:
a second processor adapted to determine said received communication message is addressed to a location based service.

8. The apparatus as claimed in claim 6 further comprising:
a third processor adapted to identify said mobile operator based on said received communication message; and wherein said third processor is further adapted include an identification of said mobile device in said request message.

9. The apparatus as claimed in claim 6 in which said first processor is adapted to process said communication message to append said received location data to said communication message.

10. A computer program product comprising computer readable executable code for:
receiving a communication message from a mobile device of a user wherein said communication message is addressed to a location based service;
transmitting a request message for a location data of said mobile device to a mobile operator of said user;
receiving a response message from said mobile operator wherein said response message includes said location data for said mobile device;
processing said communication message to include said received location data for said mobile device; and
transmitting said processed communication message to said location based service.
